(19) United States
(12) Patent Application Publication
(10) Pub. No.: US 2024/0401928 A1
(43) Pub. Date: Dec. 5, 2024

(54) DETERMINATION OF A CHANGE OF OBJECT'S SHAPE

(71) Applicant: Nikon Corporation, Tokyo (JP)

(72) Inventors: Eric Peter Goodwin, Oro Valley, AZ (US); Goldie Goldstein, Tucson, AZ (US)

(73) Assignee: Nikon Corporation, Tokyo (JP)

(21) Appl. No.: 18/803,335

(22) Filed: Aug. 13, 2024

Related U.S. Application Data
(62) Division of application No. 17/595,137, filed on Nov. 9, 2021.
(60) Provisional application No. 62/846,113, filed on May 10, 2019.

(51) Int. Cl. G01B 9/02; G01B 9/02098; G01B 11/16

(52) U.S. Cl. CPC G01B 9/02095; G01B 9/02098; G01B 11/162

(57) ABSTRACT

Surface changes are estimated using multiple speckle interferograms acquired using beams incident at different angles. Beam irradiation conditions can be changed to increase signal to noise ratio with averaging, such as weighted averaging. Irradiation conditions can be varied with a tilt plate, a wedge, or by changing beam wavelengths.

### CROSS REFERENCE TO RELATED APPLICATION

This application is a divisional of U.S. patent application Ser. No. 17/595,137, filed Nov. 9, 2021, which is the U.S. National Stage of International Application No. PCT/US2020/032234, filed May 8, 2020, which was published in English under PCT Article 21 (2), which in turn claims the benefit of U.S. Provisional Patent Application No. 62/846,113, filed May 10, 2019, all of which are incorporated herein in their entirety.

### TECHNICAL FIELD

The disclosure pertains to measurement of a change of a shape of a surface using interference of sheared speckle patterns.

### SUMMARY

Embodiments provide an optical system that includes (1) an irradiation unit containing at least first and second radiation sources (here, the at least first and second radiation sources are configured to generate radiation in a form of corresponding optical outputs containing, respectively, the first and second output beams of radiation; and one or more of spectral and geometrical parameters characterizing the first and second output beams during the propagation of these first and second output beams from the first and second radiation sources is changeable in response to an input applied to the irradiation unit); (2) a measurement unit including: a radiation detector; an aperture stop having an aperture stop axis; (3) an optical-wavefront-multiplier system; and (4) a data-acquisition system operably cooperated with the radiation detector and configured to determine a change of an object's shape, based on a determination of Fourier Transforms of only respectively-corresponding subportions of the first and second images formed by/at the detector. The measurement system is configured i) to receive an input radiation wavefront, formed as a result of propagation of the first and second output beams that have been modified by interaction of these beams with an object under test, through the aperture stop, ii) to form at least first and second radiation wavefronts by duplicating the input radiation front, and iii) to direct the at least first and second radiation wavefronts onto the radiation detector in order to form (a) a first set of respectively-corresponding first and second images representing Fourier Transforms of distributions of the radiation at the aperture at a first moment in time, and (b) a second set of respectively-corresponding first and second images representing Fourier Transforms of distributions at the aperture at a second moment in time.

### BRIEF DESCRIPTION OF DRAWINGS

These and other features will be more fully understood by referring to the following Detailed Description in conjunction with the Drawings, of which:

FIG. 1A illustrates a representative system for measuring surface shape changes, including in-plane surface changes.

FIG. 1B illustrates a representative aperture for use in the system of FIG. 1A.

FIG. 1C illustrates a representative method of determining surface shape changes using a system such as illustrated in FIG. 1A.

FIG. 2 is a schematic illustration of an embodiment of an optical system configured to measure the deformations of the workpiece in a direction transverse to a chosen surface of the workpiece.

FIG. 3 illustrates a spatial distribution of radiation across the workpiece produced with the embodiment of FIG. 2.

FIG. 4A depicts spatial elements and/or components of the of an optical measurement system configured to include the assessment of the “in plane” deformations of the chosen surface of the object under test.

FIG. 4B is a schematic illustration of an embodiment of an optical measurement optical system implementing the capabilities shown in FIG. 4A.

FIG. 4C is a schematic illustration of an embodiment of an optical measurement optical system using a single source that is operable to direct beams to a surface at different angles.

FIGS. 5A-5B contain raw images of speckle interferograms formed at the detector of an optical measurement system as disclosed wherein based on light reflection/scattering from the object under test.

FIG. 6A is an image representing a two-dimensional Fourier Transform of the irradiance distribution of the image of FIG. 5A.

FIG. 6B is an image representing only one (single) chosen order of the image of FIG. 6A.

FIGS. 7A-7B depict spatial (across the image plane) distributions (maps) of phase values of the image data of FIGS. 5A-5B, respectively.

FIG. 8 illustrates a phase difference map corresponding to a differences between the maps of FIGS. 7A-7B.

FIGS. 9A-9B illustrate spatially-smoothed sine and cosine functions of the phase difference of FIG. 8.

FIG. 10 depicts the distribution of the spatially-filtered first derivative of the phase difference of FIG. 8.

FIG. 11 shows a distribution of the spatially-filtered first derivative of the phase difference of the two speckle interferograms acquired under conditions that differed from those corresponding to FIGS. 5A-5B and that resulted in a more uniform illumination of the chosen surface of the object under test; the units of the gray scale are radians/shear distance.

FIG. 12 is a spatial map showing data representing typical repeatability of the measurement of the axial (along the axis transverse to the object's surface) deformation of the surface of the object under test; color scale in mm.

FIG. 13 is a table summarizing mathematical expressions relevant to the determination of the deformation of the surface of the object under test based on the experimental data acquired the disclosed optical systems and methods.

FIGS. 14A-14B show spatial maps of deformations (error values, in nm) assessed with the use of various expressions of FIG. 13.

FIG. 15 addresses the physical meanings of various terms referred to in FIG. 13 by showing the applicable geometry of a set-up, where the origin is the center of the test object.

FIG. 16A is a plot illustrating the irradiance distribution for speckle phase ranging from 0 to 2η.

FIG. 16B shows a relative histogram of the distribution of the irradiance in a speckle image.

FIG. 17 is a diagram illustrating a representative computing environment for calculation of shape phases, changes, and other parameters, control of data acquisition and beam sources, and transmission of shape other results.

### DETAILED DESCRIPTION

The disclosed methods and apparatus can be used to measure various shapes and deformations of surfaces including chuck-inducted deformations of semiconductor wafers, parts fabricated using so-called 3 D printing such as laser-powder bed fusion (L-PBF), e-beam powder fusion (e-PBF), or laser metal deposition (LMD), powder surface shape or powder surface unevenness in PBF printing, and riblet structures formed using laser processing. Examples of shaping methods and apparatus are described in, for example, U.S. Patent Application Publications 2017/0304946, U.S. 2017/0304947, PCT Patent Publication WO2019/133553, and European Application No. 17930076.9, all of which are incorporated herein by reference in their entireties. In evaluation of chuck-induced deformations, a roughened wafer can be used to produce speckle patterns used to assess in-plane and out-of-plane shape changes. Such roughening can be associated with a predetermined spatial frequency of interest which can be selected to enhance light collection efficiency. Generally, surfaces having arbitrary shapes can be assessed with the disclosed approaches, although for convenient illustration, shapes of interest are depicted as being planar.

As disclosed herein, a determination of a change of a shape of a surface of an object (or a complex surface of the workpiece, interchangeably referred to as surface under test, or SUT, or object under test, or workpiece under test) at any point within the bounds of such SUT is effectuated by analyzing a portion of interest (POI) of a light distribution defined by the use of two overlapping optical wavefronts. Each of these two overlapping wavefronts contains information about the light-scattering characteristics of the SUT and each of these wavefronts is a spatial copy (also referred to as a duplicate) of the other and is formed from a beam of radiation that has interacted with the SUT. Notably, as discussed below, the determination of the change of the object's shape can be carried out across the whole surface of the object in single measurement process as long as light can be received at an aperture of a measurement optical system from every point of the surface in a straight line without obscuration.

As used herein, the expression “complex surface” refers to a surface of substantially any and/or every shape, for example, whether planar, or curved, or containing surface portions connected to one another at points at which a function specifying the surface shape of the SUT is not fully differentiable and having light-scattering properties at an operational light wavelength of choice that generally include any of being specularly reflecting, optically diffusive, optically scattering, or any combination thereof. Surfaces that are at least partially optically diffusive or scattering are generally preferred.

In some examples, the disclosed approaches cure the inability of existing systems to measure shape changes on large, complex surfaces. Such conventional methods typically use an optical beam having a beam width that is much smaller than a surface area of interest. Such beams can have dimensions that are at least one or two orders of magnitude smaller than the extent of the SUT.

A portion (or subset) of interest (POI) of a light distribution, acquired with the optical detection system for the purposes of the determination of the change in the shape of the object is defined by a Fourier Transform of the light distribution, formed by the beam of light at a pre-determined plane of the measurement portion of the optical system, at one or more spatial frequencies characterizing differences in angular propagation characteristics of the two wavefronts. Notably, the carrier frequency may also depend on the location of the tilted mirror relative the pupil plane, and the focal length of the lens, but those parameters are generally fixed, in practical implementations of the system. In particular, the pre-determined plane may include a pupil or an aperture stop through which light that has interacted with the SUT is collected by the measurement portions of the optical system, while such light distribution at an optical detector of the optical detection system contains a speckle pattern.

Also addressed is the problem of improvement of accuracy of the so-carried-out determination of a change of a shape of the SUT. This particular problem is solved by performing the process of the determination multiple times, under differing measurement conditions, each of which can be selected to provide repeatable and pre-determined change(s) in the speckle pattern to reduce the contribution of low-light areas of any speckle to the overall measurement error. In a specific case, the measurement-accuracy improvement factor is substantially equal to a square root of the number of measurement conditions.

### Example 1. Representative Measurement System

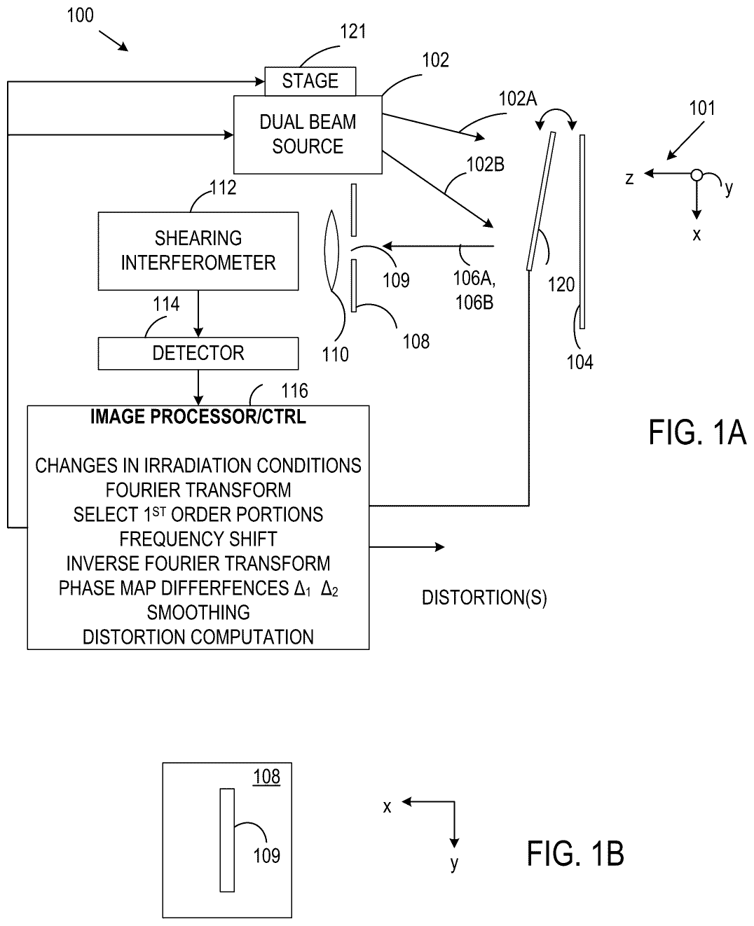

Referring to FIGS. 1A-1B, a representative system 100 operable to determine in-plane and out-of-plane shape changes of a surface 104 includes a dual beam source 102 that is configured to direct at least a first beam 102A and a second beam 102B to the surface 104. The first and second beams 102A, 102B are incident at different angles of incidence, typically differing by at least 10, 15, 20, 25, or 30°, and often at angles that are symmetric with respect to an axis that is perpendicular to the surface 104. The surface 104 is shown as planar, but any surface shape can be similarly evaluated. Typically, the beams 102A, 102B are at a common wavelength and are applied sequentially. If at different wavelengths, the beams 102A, 102B can be applied simultaneously and one or more filters used so that responses can be separately processed. Optical beams 106A, 106B responsive to the beams 102A, 102B, respectively, are directed to a spatial filter 108 that defines an aperture 109 that is selected to produce a suitable speckle pattern. A narrower aperture width measured in a direction parallel to an x-axis in a right-handed Cartesian coordinate system 101 results in larger speckles in images based on the optical beams 106A, 106B. The aperture dimension in a y-direction (out of the plane of the drawing) can be large to increase light collection efficiency. With such a spatial filter, the speckles in the resulting images are relatively bigger in the x-direction and relatively smaller in the y-direction and can appear cigar-shaped. A representative rectangular aperture for the spatial filter 108 is illustrated in FIG. 1B.

A lens 110 is situated to image the surface 104 into a shearing interferometer 112. The shearing interferometer 112 is situated to receive each of the beams 106A, 106B as processed by the lens 110, divide the beams 106A, 106B, and produce two sheared beam portions from each of the beams 106A, 106B. The sheared beam portions are directed to a detector 114 which produces interference patterns corresponding to each pair of sheared beam portions. A fringe period (or carrier frequency) can be adjusted by selection of a relative tilt between the two beam portions at the detector 114. The two sheared images exhibiting interference and speckle are directed to an image processing/control system (“controller”) 116 that is operable to perform Fourier transforms, inverse Fourier transforms, frequency shift Fourier transformed images, determine and smooth phase differences (Δ₁, Δ₂). Processing spatially filtered, sheared speckle images associated with each of the beams 102A, 102B for each measurement time of interest permits assessing in-plane surface changes. Typically, smoothed phase differences (Δ₁, Δ₂) are obtained at measurement times t₁, t₂, . . . as needed.

The controller 116 is also coupled to change irradiation conditions. As shown in FIG. 1A, the controller 116 is coupled to the dual beam source 102 to change irradiation wavelengths, angles, beam shapes, beam planes of incidence or other characteristics to permit shape measurement in different directions and to obtain measurements suitable for averaging or weighted averaging. In one example, a tiltable plate 120 is coupled so that tilt angle can be varied to produce independent speckle patterns. The tiltable plate 120 can be a plane parallel plate or a wedge to displace beams or vary angles of incidence. A stage 121 can be coupled to the dual beam source 102 to displace (x,y,z) or rotate the source to create different images. The surface 104 can be manipulated in the same manner, but it is generally difficult to control such manipulation precisely enough.

In the example of FIG. 1A, surface changes in the x-direction are obtained based on phase differences (Δ₁ₓ, Δ₂ₓ) because the beams 102A, 102B are in the xz-plane; phase differences (Δ_{1y}, Δ_{2y}) can be obtained using beams in the yz-plane. The beam source 102 can include one or more radiation sources such as lasers, or a propagation axis of a single source can be varied to acquire phase differences along any directions of interest, such as in both xz- and yz-planes.

### Example 2. Representative Measurement Methods

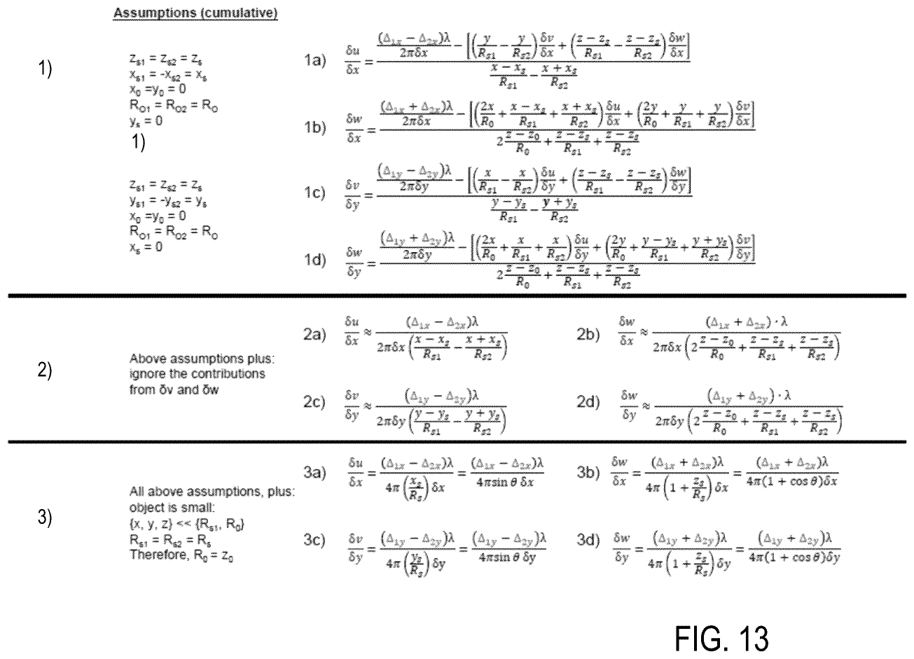

Referring to FIG. 1C, a representative method 150 includes acquiring spatially filtered first and second initial sheared speckle images of a surface under test (SUT) in an initial state using first and second beams. Spatial filtering is applied to produce a selected speckle pattern, typically with a narrow spatial filter in a plane in which SUT in-plane distortion is to be measured. Shearing can be applied with various interferometers to select a fringe frequency. The first and second initial sheared speckle images may be acquired based on irradiating first and second beams on a reference surface which is different from the surface under test. At 154, the SUT is deformed or is otherwise in a different state than the initial state, and first and second subsequent sheared speckle images of a surface under test (SUT) in subsequent state are obtained using the first and second beams at 156. If a reference surface is used, step 154 may be skipped. Each of the sheared speckle images (initial and subsequent states) is processed with a Fourier transform at 158, followed by selecting a first order portion of the Fourier transform at 160. The first order portions are shifted to zero spatial frequency at 162, and the shifted portions inverse Fourier transformed at 164 to produce phase maps (phase maps for the initial and subsequent states with each of the first and second beams). Phase map differences 41, 42 are obtained as differences between phases of the phase maps for each of the first and second beams at corresponding locations on the SUT. To reduce the effects of phase discontinuities, the phase map differences are smoothed at 168, and in-plane or out-of-plane distortion is determined at 170 using, for example, the relationships shown in FIG. 13.

### Example 3. Representative Measurement System

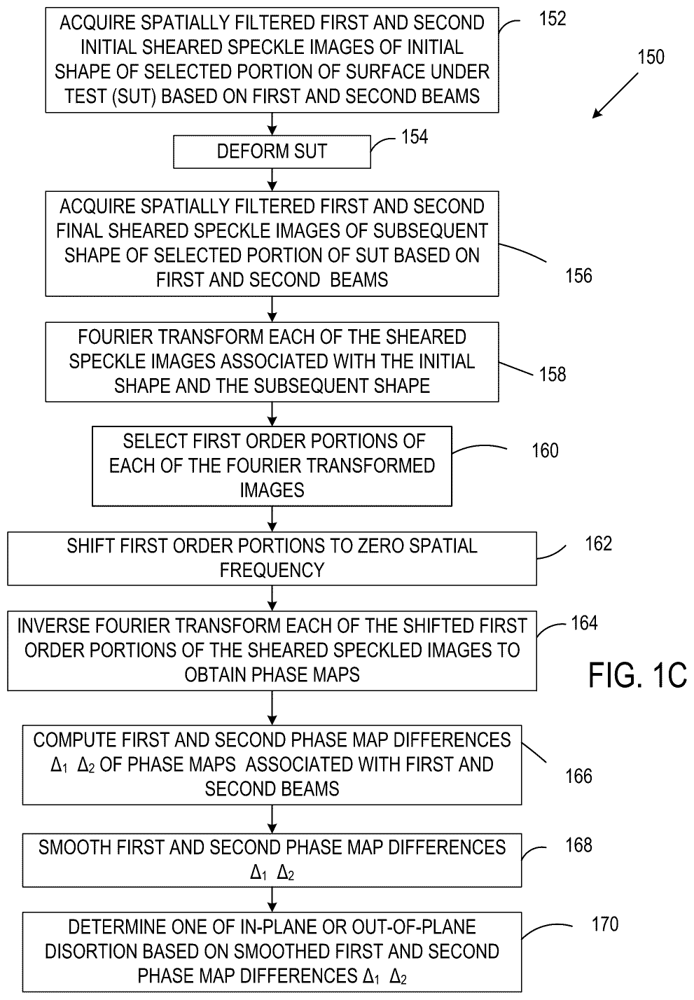

FIG. 2 is a schematic illustration of the optical system 200 configured to perform the measurement of the deformations of the workpiece along the z-axis. In this example, the optical system 200 was designed for an object at infinity with the field size determined by angle in the object space angles (in one implementation-up to) 15°, to ensure that the angular extent of a single pixel of the optical detector remains a constant regardless of the object size. In one implementation, the optical system was designed for monochromatic operation (λ=532 nm). As shown in this specific embodiment, the optical system includes a radiation-splitting component 210, re-directing a portion of the radiation input 220 towards the object-under-test 222 through a lens 224 possessing negative optical power (indicated with reversed arrows); a positive lens 228, disposed to collect a portion of the radiation input delivered from the irradiated object 222 through the aperture stop 232; and an optical-wavefront duplicator unit 236 shown in this implementation as a combination of a beamsplitter 236A and two reflectors 236B, 236C, at least one of which is appropriately tilted with respect to the optical axis 240 such as to ensure the pitch of the interference fringes, formed by the two duplicates of the optical wavefront is substantially constant across the optical field). The radiation-splitting component may refer to a radiation-combining component, or a beam splitter, or a beam combiner. Typically, tilt is applied at a location close to but slightly away from an intermediate image plane, resulting primarily in tilt at a detector. However, because it is applied slightly away from the intermediate image plane, it is also responsible for a shear distance.

The optical workpiece-observation system 200 includes a combination of lenses configured to relay an image of the workpiece 222 to a camera 244 while transmitting radiation through an optical-wavefront duplicator device: in the specific embodiment 200 as shown, the radiation field producing the speckle and originating at the workpiece 222, is split into two sibling radiation fields (optical wavefronts, each of which is the duplicate of the other) using a 50/50 or other beamsplitter. Each of the two wavefronts is reflected by a corresponding reflector (either 236B or 236C). If one of these reflectors is tilted about the y-axis, this results in an angular tilt introduced between the two wavefronts and a translational separation the amount of each of which depends on the optics design, tilt angle, etc. Specifically, if one of these reflectors is tilted about the y-axis, there appears an angular tilt introduced between the two wavefronts. When these two wavefronts are relayed to the CCD 244, they will have a translational separation and a tilt, the amount of each of which depends on the optics design, tilt angle, etc. These two wavefronts are combined and measured with the CCD 244. The two beams representing these two optical wavefronts are then spatially recombined and the spatial distribution of radiation is acquired and measured with the CCD 244.

A person of skill will readily appreciate that, while the difference between the angles of propagation (alternatively referred to as shear angle) of the duplicated optical wavefronts, generated at the optical-wavefront duplicator 236, remains substantially constant in the object space, the separation between these two duplicated wavefronts expressed in terms of distance (which can be referred to as shear distance) in the object space depends on the distance to the object at hand.

It will be appreciated by a skilled person that one advantage of this optical system is that the aperture stop 232 (disposed between the optical lenses 224, 228 and configured, for example, as a slit at the plane of the pupil of the optical system that extends in a direction perpendicular to the direction of the measurement) practically limits the working f-number of the optical system (and accordingly, the spatial frequency at which the speckle-related radiation propagates) in the direction of shear-in the example of FIG. 2, in the x-direction, which in turn relaxes the demand for correction of aberrations and increases depth of focus. The latter, in turn, substantially removes the need for focus compensation (when working with closely-disposed objects), so common in the systems of related art, thereby providing an operational advantage over the systems of related art. Moreover, the use of the rectangular slit extended in a single linear direction in an xy-plane is facilitated by the fact that there is no anti-aliasing requirement in the perpendicular direction (y-axis, in this example). The so-shaped aperture stop allows much more light through the system than a square or circular aperture would. The aperture stop 232 and the detector 244 are disposed at the locations judiciously chosen to make the distribution of the radiation field at the detector 244 to be substantially a Fourier Transform (FT) of the radiation distribution at the aperture stop 232.

The aperture stop 232 can be alternatively disposed between the test object 222 and the lens 224. However, in this case the period of interference fringes, formed by the two duplicates of the wavefront arriving from the object 222 at the detector, is increased several fold (and up to by an order of magnitude) for the same difference between the angles of propagation of the two duplicated wavefronts towards the detector, as compared to the situation depicted in FIG. 2. This is generally not preferred as it can cause complications in accuracy and/or precision of the determination of the changes in shape of the object's surface.

According to a specific embodiment, the input flux of radiation 220 (dimensioned as a beam with the numerical aperture NA of about 0.19 in one non-limiting implementation) was injected into the optical system 200 at an axial location between the lenses 222 and 228. The presence of the negative-power optical element 222 serves to expand the field of view (up to 15 degrees, half-FOV in object space) to completely fill the test part 222. The aperture stop is dimensioned as a rectangular and disposed at a pupil plane to control the size of the speckle and to limit the NA of the whole system 200. The wavefront duplicator 236 is preferably located closer to the image plane (defined at the surface of the only, single optical/radiation detector 244, to which the radiation is delivered through the combination of positive lenses 246, 248) to allow for the sought-after large difference of angles of propagation between the duplicated wavefronts and a small shear distance. “Large” difference angles produce diffraction orders that can be fully separated when the image is Fourier transformed.

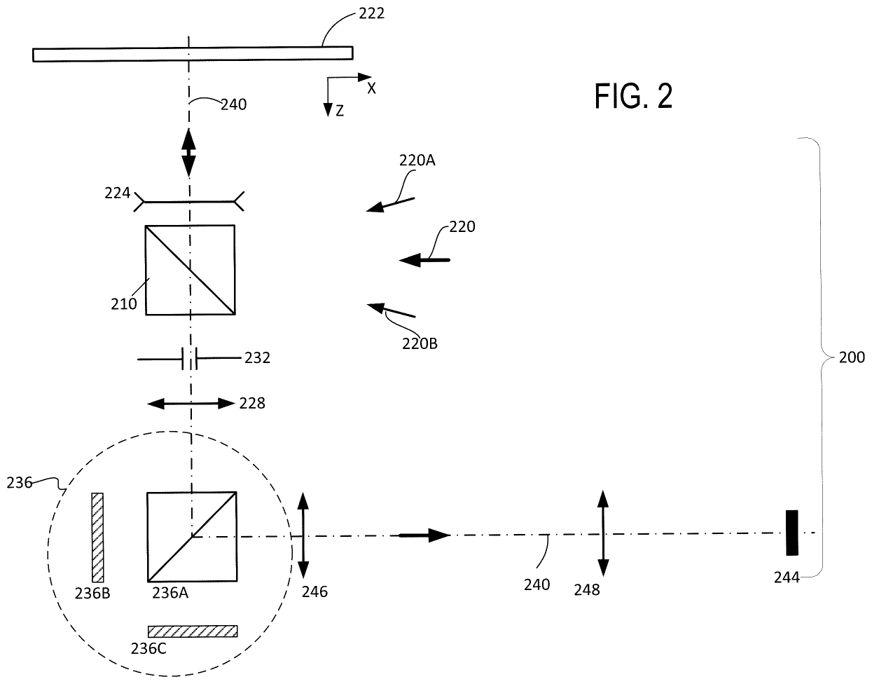

In choosing the optical characteristics of the components of the optical system of FIG. 2, optical distortion should generally be limited such that the pitch of the optical fringes, projected onto the workpiece 222, be constant across the workpiece 222 and to minimize any mapping issues. In the case when the distribution of radiation delivered to the workpiece is substantially Gaussian, a practical limit may be imposed on the useable region of the workpiece-under-test. FIG. 3 provides an example of the empirically-registered spatial distribution of radiation across the object (workpiece) 222.

In one example, the opto-geometrical parameters of the constituent components used in the optical system 200 were as follows: a focal length of lens 224: f₂₂₄=−25 mm; a width of the (slit) aperture stop 232: W₂₃₂=3 mm; a focal length of the lens 228: f₂₂₈=60 mm; a focal length of the lens 246: f₂₄₆=125 mm; a focal length of the lens 248: f₂₄₈=80 mm; pixel size of the camera 244: 4-by-4 μm²; beamsplitter 236A: 50/50. The object under test 222, in one embodiment, was configured as a 300 mm diameter wafer and, with the distance of about 800 mm separating the lens 224 from the object 222, the FOV of the radiation incident onto the object was sufficiently large to irradiate all of the surface of the object 222 at once.

In other examples, the wavefront-duplicator device 236 can be alternatively implemented as an optical diffractive component configured to generate, in diffraction of radiation incident onto such component, two beams, each defining a corresponding one of the two duplicated wavefronts. For example, the wavefront duplicator device may include a diffraction grating, disposed at a plane of a reflector of the unit 236 and equipped to generate only the zeroth and +1^{st} (or, alternatively, the zeroth and −1^{st}) orders of diffraction. The geometrical parameters of such diffraction grating are judiciously chosen to keep the fringe pitch constant across the optical field. In a related embodiment, the optical diffractive component can be structured as by a reconfigurable spatial light modulator (or SLM). In yet another implementation, the wavefront-duplicator portion of the optical system may include a Wollaston prism or Savart plates. The implemented optical-wavefront-duplicator unit is generally repositionable (strictly based on its properties and the desired relationship between the shear distance and the shear angle but without the ability to just arbitrarily place it axially anywhere) along the optical axis 240, once the shear angle has been chosen. In any implementation, the exit pupil can be controlled to be substantially at infinity so that the optical system 200 remains telecentric in image space.

To perform to in-plane measurements of the workpiece 222 (that is, the deformations of the workpiece occurring, as a result of, for example, chucking the workpiece, in the plane substantially perpendicular to the optical axis of the optical system 200) multiple sources of input radiation (multiple source points) are required. FIG. 2 illustrates beams 220A, 220B that can be directed to the workpiece 222 at different angles and can be produced with the same or different sources.

### Example 4. Representative Measurement Systems with Multiple Radiation Sources

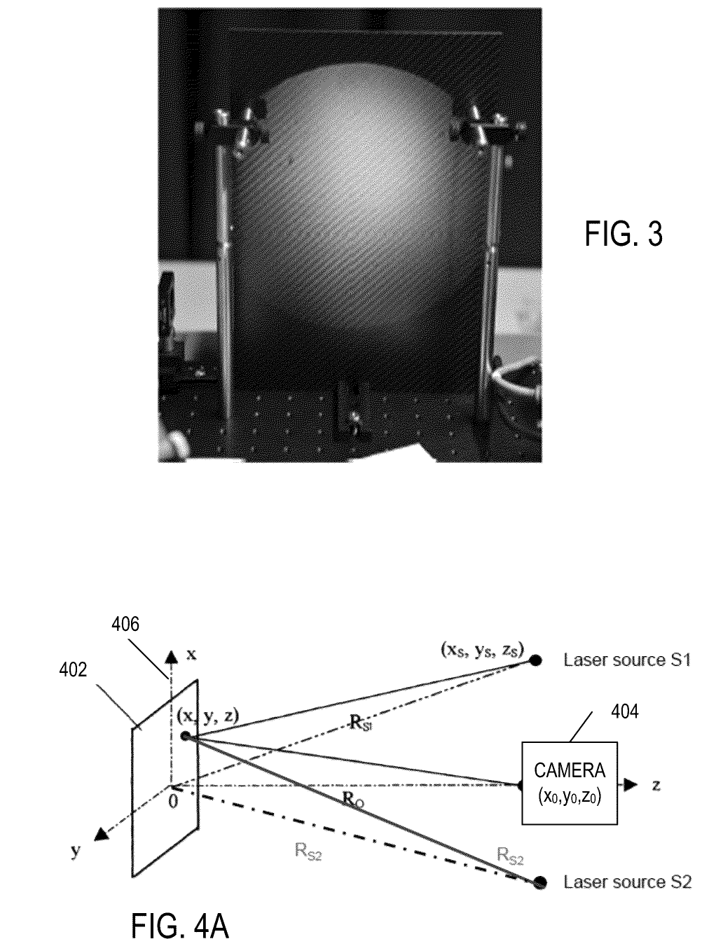

Referring to FIG. 4A, a surface of an object 402 and two laser sources S1, S2 facilitate measurements along one in-plane axis (for example, measurement of the distortions of the object surface along an x-axis 406) with the single radiation detector shown as camera 404. Coordinates associated with the laser sources S1, S2 and the camera 404 are shown as well. In this example, propagation vectors of the beams from the laser sources S1, S2 are in an xz-plane. While not illustrated in FIG. 4A, the practical implementation of the two-radiation-sources-containing optical measurement system is structured by analogy with that of FIG. 2, where two different input fluxes of radiation are injected into the system from respectively-corresponding radiation sources, preferably, in such as a fashion as to deliver these fluxes of radiation onto the object under test at substantially equal but opposite angles of incidence causing the respective sensitivity values to the motion of the workpiece along the z-axis to have opposite signs. Just as in the case of the embodiment 200 of FIG. 2, the wavefront-duplicator device of the schematic 400 can be implemented, for example, with the use of an optical diffraction grating configured to generate only two orders of diffraction (for example, the zeroth and the +1st orders).

Referring to FIG. 4B, a shape measuring system 450 includes laser sources 452, 454 that direct respective beams to lenses 453, 455 along different propagation axes in an xz-plane. Beam portions returned from a target object 458 are spatially filtered with an aperture 460 and beams responsive to both the laser sources 454, 454 are returned along a direction 462. Such beams can be referred to as spatially filtered (by the aperture 458) speckle beams as they can produce speckle patterns. These beams can be coupled to a wavefront-duplicator such as the shearing interferometer 236 discussed above, which produces corresponding sheared, spatially filtered speckle beams.

To carry out both the in-plane measurement of the distortions of the object surface along the two in-plane axes (both the x-axis and y-axis) and the measurement of the workpiece distortion along the axis transverse to the surface of the object (that is, the z-axis as shown in FIG. 4B), at least three radiation sources are required. In one implementation, two additional radiation sources (not shown for simplicity of illustration) may be required. In performing in-plane distortion measurements, the angles of irradiation of the object's surface need not be equal at all locations across the object's surface, the distances from the radiation source to a measurement point on the object's surface need not be the same for each of the multiple radiation sources. The object (workpiece) need not be small in comparison with the distance to the radiation sources and/or the camera.

### Example 5. Representative Single Beam System

Referring to FIG. 4C, a shape measuring system 470 includes a single beam source 472 that directs a polarized beam to a switchable waveplate 474 that couples a beam in a first or second state of polarization to a polarizing beam splitter (PBS) 478. In a first SOP, the beam propagates to a mirror 480 and is reflected to a target surface 482, typically as a diverging beam 481 that can irradiate a substantial portion of the target surface. In a second SOP, the PBS 478 transmits the beam to mirrors 484, 486 that direct a diverging beam 487 to the target surface 482. An aperture 490 is situated to spatially filter returned beam portions, a lens 491 images the target surface 482, and a shearing interferometer produces sheared, spatially filtered speckle images that are detected with a detector 494 (typically an array detector) for processing at a controller/processor 476 that is coupled to select the diverging beam 481 or the diverging beam 487. In this example, a single beam source is operable to produce beams along different axes.

In practice, either the single-source embodiment of FIG. 2 or a multi-source embodiment of the measurement system can be used to measure the spatial distortion (the change of the shape) of the workpiece surface that has substantially any shape (and is not limited to the measurements of the planar surface) as long as there is no occlusion of light. The beams are preferably configured to reach the entire surface, and the observation system preferably has to have a direct line of sight to every point on the surface under test.

As discussed above, an optical measurement system as shown in FIG. 4B can measure “in-plane” deformation of the chosen surface of the object under test with multiple optical sources and a single radiation detector. FIG. 4B does not show a negative lens used to distribute the beam for convenient illustration.

Only two sources S1, S2 are shown, but in practice to measure the deformations along two mutually-transverse axes disposed in the SUT of an object at least three radiation sources may be used (beams along three axes defining two different planes). Multiple sources of radiation can be chosen to generate/emit corresponding portions of radiation with the same spectral content (for example, at the same wavelength λ₁=λ₂) or with different spectral content (for example, at different wavelengths λ₁≠λ2). When the multiple sources operate at different wavelengths, their operation may be subjected to strobing at the detector or, alternatively, arrangements can be made to perform the measurements simultaneously at these different wavelengths. When the multiple sources operate at substantially equal wavelengths, the strobing or time-multiplexing of the measurement is generally preferred.

### Example 6. Representative Measurements

It is understood that, in operation, the camera 244 and other detectors discussed above register the spatial distribution of radiation that includes interference fringes caused by interference between the two duplicate wavefronts reaching the detectors from the rough surface of the object through the wavefront-duplicator that are heavily modulated by the presence of speckle caused in reflection and scatter of the radiation from the surface of a workpiece. Such registered spatial distribution of radiation at the detector is referred to as a speckle interferogram.

The optical measurement systems as disclosed provide the change in the spatial derivative of the height of the measured surface of the workpiece (dw/dx) between image frames N and N+1. If the height change between two frames is desired, the result must be integrated spatially (either along the x-axis, or along the y-axis, or along both axes). If there are multiple image frame pairs recorded as a function of time, then the signal needs to be integrated with respect to time to determine the surface height change over the entire measurement.

The following discussion illustrates elements of the measurement procedure performed with the embodiment of FIG. 2 (containing a single source of radiation 220 used to irradiate the object). The measurements performed with the embodiment containing multiple sources of radiation are carried out in a substantially-similar fashion.

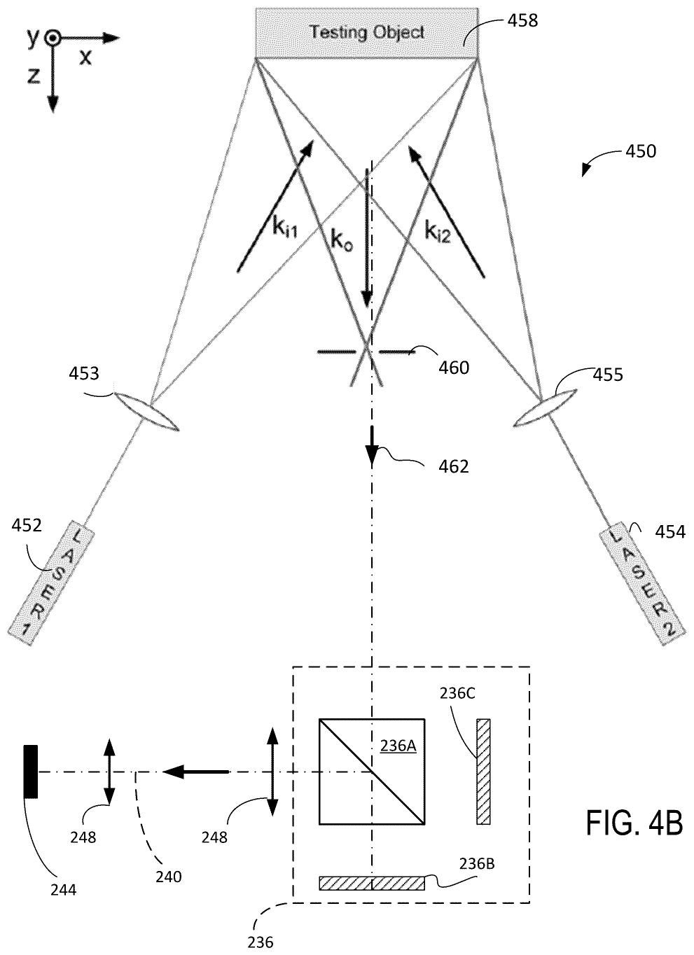

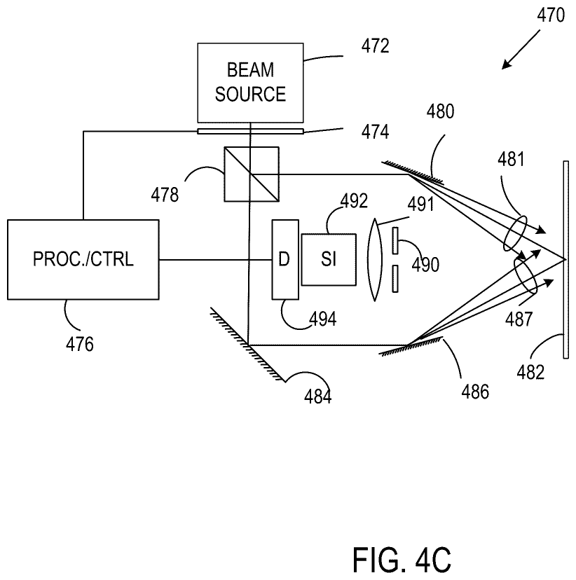

A single speckle interferogram, registered by a detector such as the detector 244, would not contain useful information about the distortions of the object. Two measurements of the surface of the workpiece are taken-before an external input is applied to the workpiece, and after the external input is applied to the workpiece, or between any two or more times at which the surface is in different states. Typical examples A and B of such raw speckle images are shown in FIGS. 5A-5B In each of these images, the digital counts of irradiance, registered by the detector, are plotted as a function of the camera pixels (along the local x- and y-axes chosen across the surface of the camera). Due to the lack of uniformity of the irradiation distribution incident onto the workpiece (˜ quasi-Gaussian, in one case), only the central region of each of the images can be seen to contain a strong enough signal level. At the next step, the phase difference between the two images is found with the use of the FT methodology. This, in turn, requires the determination of the phase distribution across each of the images of FIGS. 5A-5B. To determine this the following data manipulation may be performed: First, the FT of the data of a given speckle interferogram is determined. For example, FIG. 6A illustrates the results of a two dimensional (2 D) FT of the image A of FIG. 5A. By applying (for example, digitally) a spatial mask or filter to the image data of FIG. 6A and keeping only one portion of the image corresponding to the single chosen order of the 2 D FT, image data similar to those of FIG. 6B are obtained. The phase distribution across the image field of image A of FIG. 5A is then determined with the use of the inverse FT of the data of the image of FIG. 6B. In this example, a first order portion of FIG. 6A is used, and is shifted to a lower spatial frequency corresponding to the original 0^{th} order. Similar manipulations are performed with respect to the image of the workpiece to which the chosen external input has been applied (that is, in this example, with respect to the image B of FIG. 5B) to determine the phase distribution across the field of the image B of FIG. 5B.

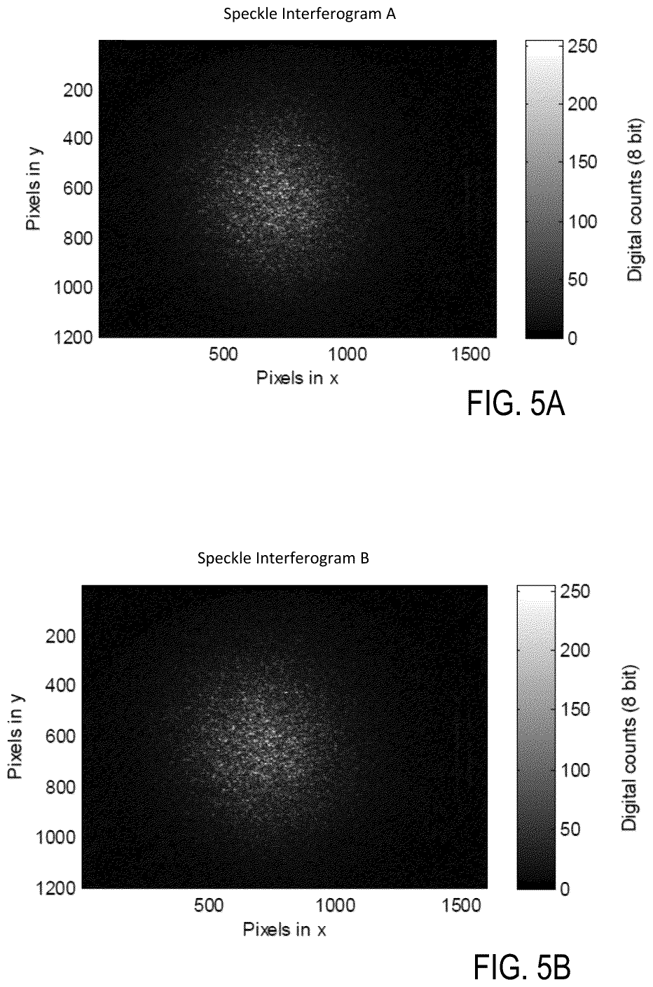

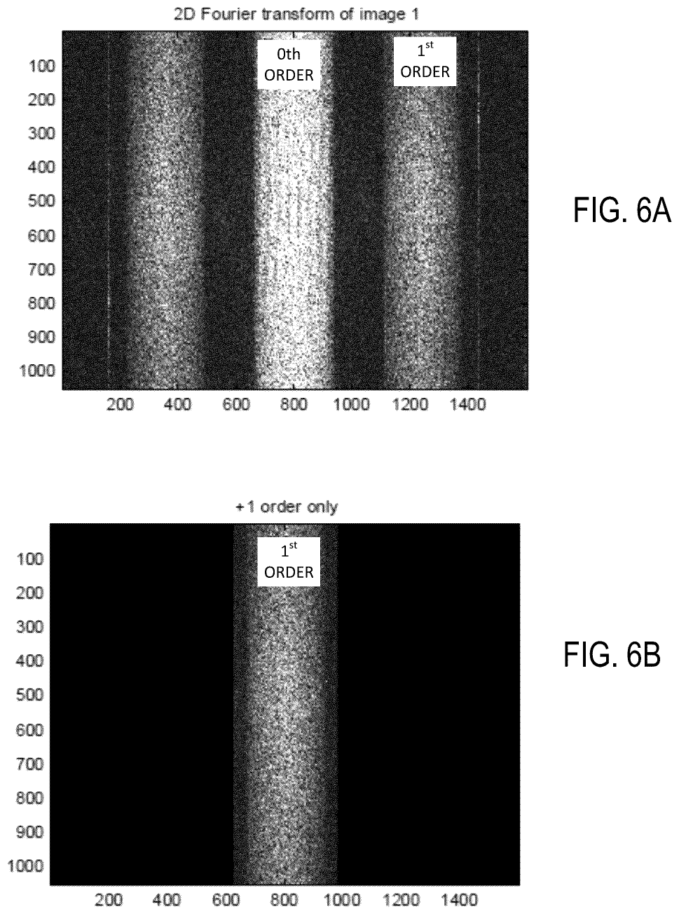

FIGS. 7A, 7B illustrate the so-determined phase distributions, respectively. The map of the phase difference 41 between the phase distributions of the “before the deformation” and “after the deformation” images of the surface of the workpiece in question is determined as a result of subtraction of the phase maps of FIGS. 7A-7B from one another- and illustrated in FIG. 8. The speckle-like appearance is due to phase wrapping and multiples of 2η phase jumps in calculated phases. The quantity 41 represents the first derivative of the phase difference with respect to x (the direction of shear between the two duplicated wavefronts of radiation formed by a shear interferometer such as the unit 236, in reference to FIG. 2). The sub-index “1” indicates the number of a source of radiation used for this specific measurement. The phase difference between the speckle interferograms obtained with the use of a second source of radiation, typically at a different direction of incidence is denoted with the sub-index “2”.)

The data representing Δ₁ may be appropriately spatially filtered to reduce the impact of the speckle modulation (generally due to phase wrapping) on the interference fringes, for example by smoothing the data representing the sine and/or cosine functions of Δ₁, and using the convolution with a boxcar (or any other known spatial filtering method), represented by the term Low Pass Filter (LPF) in the equation below. Some of the modulation in FIG. 8 is associated with phase jump in phase determination, and is reduced by smoothing as follows:

$$Smoothed \to {\tilde{Δ}}_{1} = atan \frac{L P F ( sin {Δ}_{1} )}{L P F ( cos {Δ}_{1} )} .$$

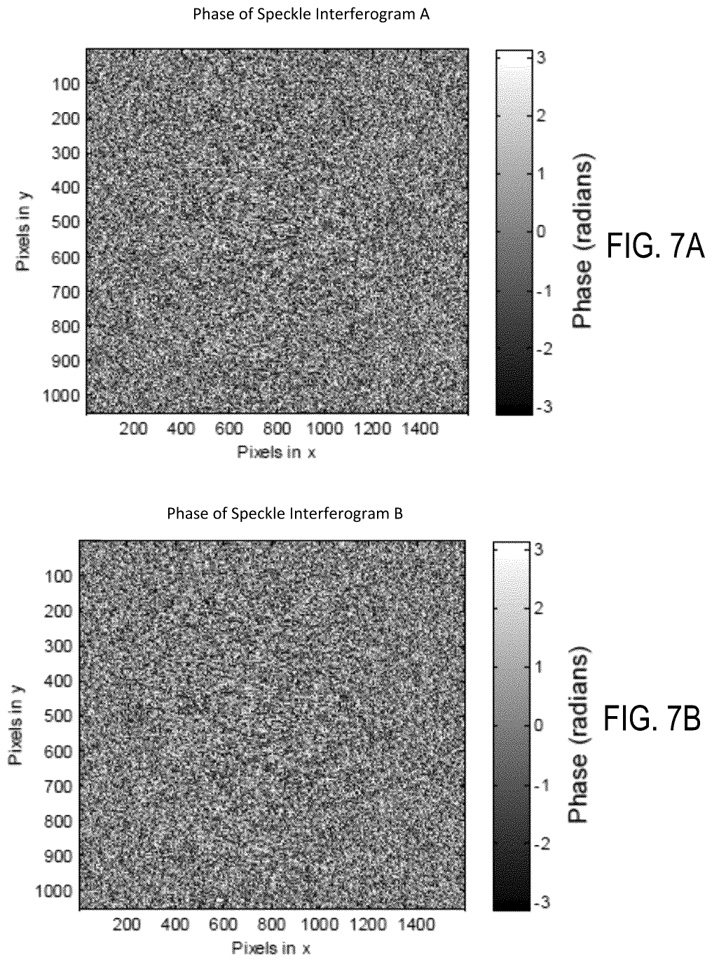

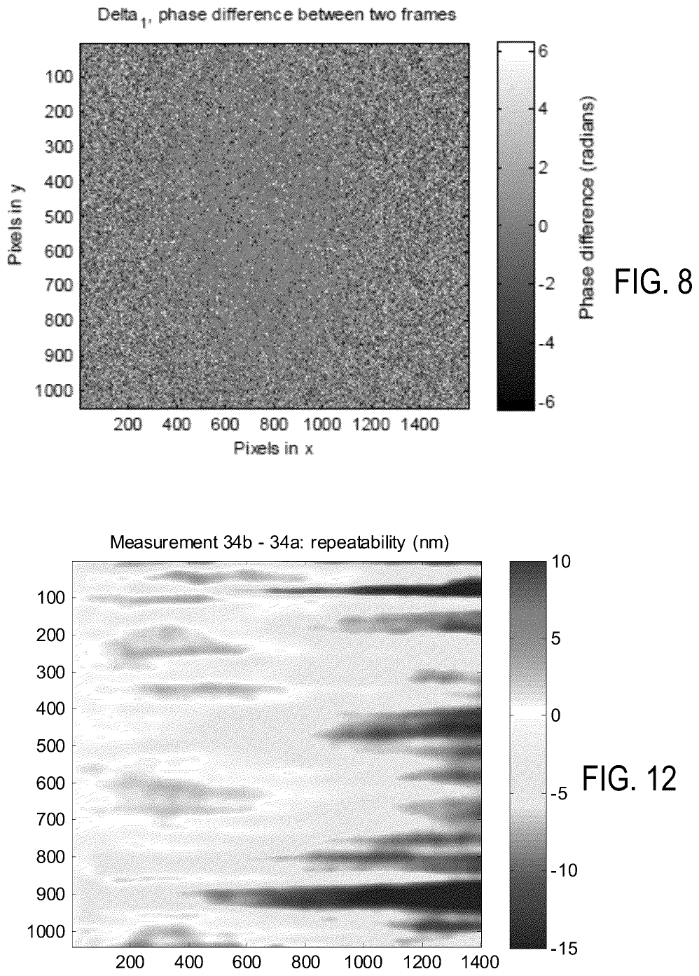

FIGS. 9A-9B provide illustrations of the spatially-smoothed sine and cosine functions of the phase differences, while FIG. 10 demonstrates [symbol] , which is the spatially-filtered first derivative of the phase difference between the speckle interferogram B of FIG. 5B and the speckle interferogram A of FIG. 5A after unwrapping. The data of FIG. 10 may be then interpreted considering the same dependency of conversion from the phase parameter to the height-of-the-workpiece-surface for every point across the object's surface, and optionally integrated (spatially, along the in-plane axis along which the deformation is being sought, and/or temporally to establish the time derivative of the object's surface height change in case multiple measurements were taken as a function of time).

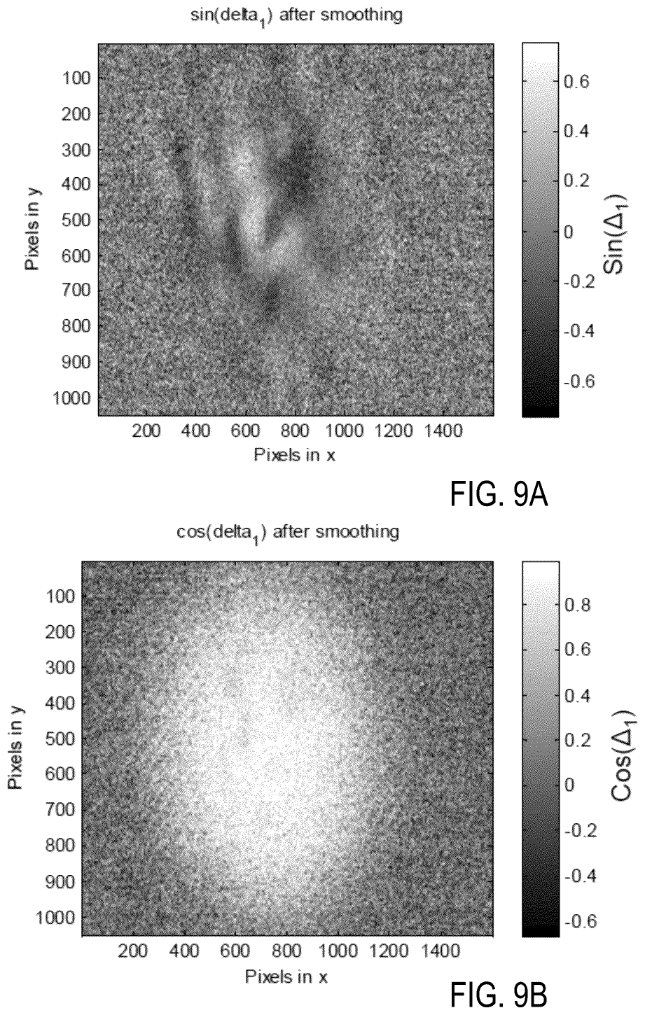

(As a result of the related measurement, in which the spatial distribution of radiation 220 used to irradiate the object 222 was substantially more uniform across the object's surface, the resulting spatially-filtered first derivative of the phase difference data is also substantially more uniform—as seen in FIG. 11.)

Notably, when the multiple sources of radiation are used in the optical measurement system (for example, two sources of radiation)—both of the results, [symbol] and [symbol] contain information about all types of the distortion of the workpiece's surface (an out-of-plane distortion along the z-axis, an in-plane distortion with respect to both x-axis and y-axis). This provides a clear operational advantage over the conventional interferometer-based methodologies of measuring the properties of the wavefront arriving at the optical detector. Indeed, when the Fizeau interferometer is used for similar measurements, for example, the optical wavefront arriving from the workpiece at the detector has to be compared with the wavefront from the reference surface (whether the reference surface us spatially non-uniform, such as the grating, or flat). Accordingly, the interferogram produced with the use of the traditional methodologies only contains information about the difference between the measured and reference surfaces; therefore, if the reference surface itself is changed or modified in some unknown fashion, it is likely to be interpreted as a change of the shape of the workpiece-under-test instead and lead to the unknown error of the measurement. In other words, the embodiment of the invention does not require- and is devoid of—the use of any reference surface in addition to the use of the surface to be measured.

Another advantage of the disclosed measurement methodology over other measurement techniques stems from the fact that no workpiece motion is required to carry out phase shifting. This is because the tilt (seen in the Fourier Transform data of FIGS. 6A-6B) allows spatial heterodyne methods to be used to extract the phase, rather than using more time consuming and mechanically complex temporal phase shifting methods.

The determination of the approximate value of the out-of-plane distortion (shown below as a derivative value along the x-axis, for example) may be estimated according to

$$\frac{\partial w}{\partial x} = \frac{{λ}_{1} ( {Δ}_{1} + {Δ}_{2} )}{4 πΔ x ( 1 + cos θ )} \qquad ( 1 )$$

while the in-plane distortion of the workpiece (along the x-axis, in this example) can be assessed according to

$$\frac{\partial u}{\partial x} = \frac{{λ}_{1} ( {Δ}_{1} - {Δ}_{2} )}{4 πΔ x ( sin θ )} \qquad ( 2 )$$

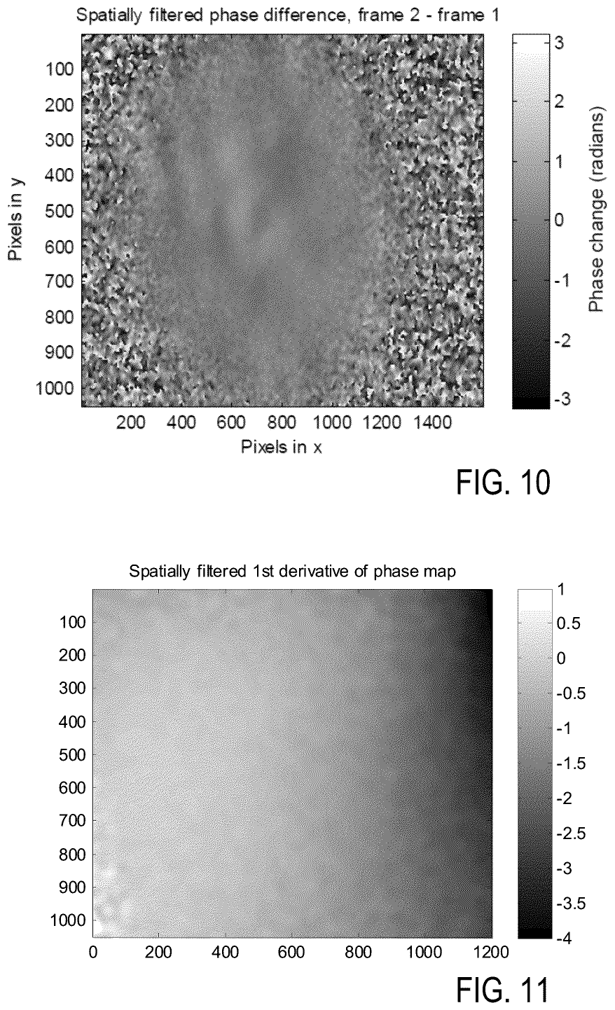

Here, θ is the angle at which the workpiece is irradiated, λ is the wavelength of the radiation used to irradiate the workpiece, and Δx is the “shear” distance between the two duplicated wavefronts formed at the duplicator unit such as the unit 236 of FIG. 2, the change in z (height) maps are obtained for two measurements. This methodology of measuring the change in shape of the surface of the object provides exceedingly repeatable results. In reference to FIG. 12, for example, for a maximum change of height of the object's surface of about 900 nm (caused by applying an external force to the object), the repeatability of the measurement is better than about +/−10 nm (with the standard deviation on the order of 2 to 3 nm).

In practice, even considering the speckle pattern optical noise that limits the imaging resolution of a system both in the xy-plane and along the z-axis (defined as shown in FIG. 2), the implementation of the representative optical system 200 possessed the following characteristics: FOV of at least 300 mm by 300 mm; resolution in xy-plane of <1 mm; resolution along the z-axis of <0.1 micron; Z-range of >100 mm; working distance of >100 mm; measurement time of <10 sec (across the complete surface of the workpiece). (Z-range represents the total range of distances along the z-axis over which a single part can be located. So a part with a smooth but large—for example, 100 mm tall-bump along the z direction could be measured, as long as the light is not blocked, or the view.)

### Example 7. Determination of Shape Changes

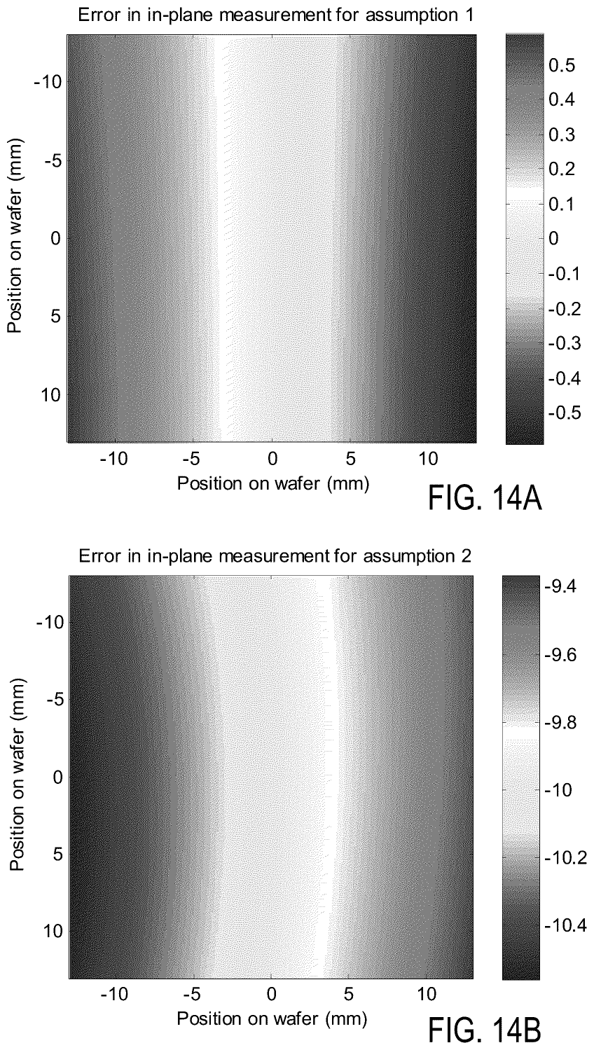

The Table of FIG. 13 summarizes the relevant expressions, where the expressions 1a) through 1d), when used, do not require making any assumptions about the geometry of the measurement that result in measurement errors. The Δ values are computed from phase measurements as discussed above, differential values such as _{δx} ^{δw} are unknown values to be determined, and the remaining values pertain to system geometry and/or calibration values. Variables u, v, w correspond to in-plane changes (x and y directions) and out-of plane changes (z-direction), wherein a z-direction is perpendicular to a SUT. Making some reasonable assumptions allow simplified calculations using the expressions 2a) through 2d). The penalty for using equations 2a) through 2d) instead of 1a) through 1d) is shown in FIG. 14A for a representative geometry and shear magnitude. Here,

$$\frac{δ u}{δ x} \approx \frac{( {Δ}_{1 x} - {Δ}_{2 x} ) λ}{2 π δ x ( \frac{x - {x}_{s}}{{R}_{s 1}} - \frac{x + {x}_{s}}{{R}_{s 2}} )}$$

If some more limiting assumptions are made about the geometry of the measurement, then equations 3a) through 3d) can be used (compare with Equations 1 and 2 above). The penalty for using these approximations in comparison with the exact expressions 1a through 1d) is illustrated in FIG. 14B. Here,

$$\frac{δ u}{δ x} = \frac{( {Δ}_{1 x} - {Δ}_{2 x} ) λ}{4 πsin θ δ x}$$

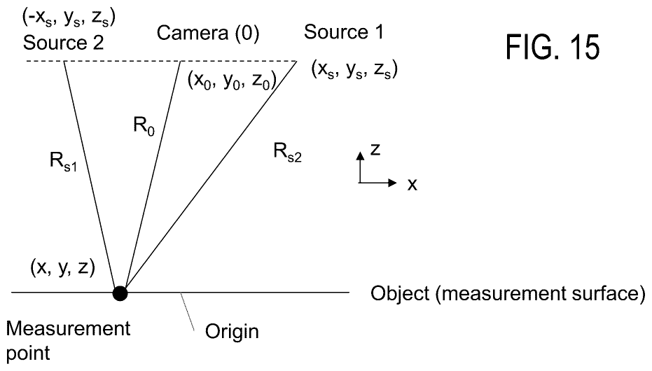

The physical meaning of various terms is defined in FIG. 1 which shows a geometry, in which an origin is a center of the test object. Both of the two sources of radiation are assumed to be in the xz-plane at the same z position and at equal and opposite x locations with respect to the axis, such that xₛ₁=−xₛ₂. The distance from source 1 to the measurement point is Rₛ₁ (similarly for Rₛ₂), and the distance from the test point to the detector is Ro. The measurement point can of course be at locations for which y is not zero, and y=0 is shown for convenient illustration in FIG. 15.

### Example 8. Increasing Measurement Accuracy

It is quite clear that as long as everything in the optical system remains unchanged-including but not limited to polarization and/or wavelength of radiation used to irradiate the SUT, the irradiation angle(s), the position of the object, the object shape and/or the position of radiation source(s), then the speckle pattern(s) formed at the image/detection plane will remain fixed.

It will also be appreciated that there exist two types of noise limiting the repeatability of the above-described measurements-specifically, random noise (such as shot noise in the camera 244, random fluctuations), and the systematic noise from the fixed speckle pattern. The random noise can be improved somewhat by averaging multiple frames. It can also be reduced by increasing the light level at the camera by increasing source power or engineering the test surface such that it sends more irradiance into the imaging system shown in FIG. 4B, for example.

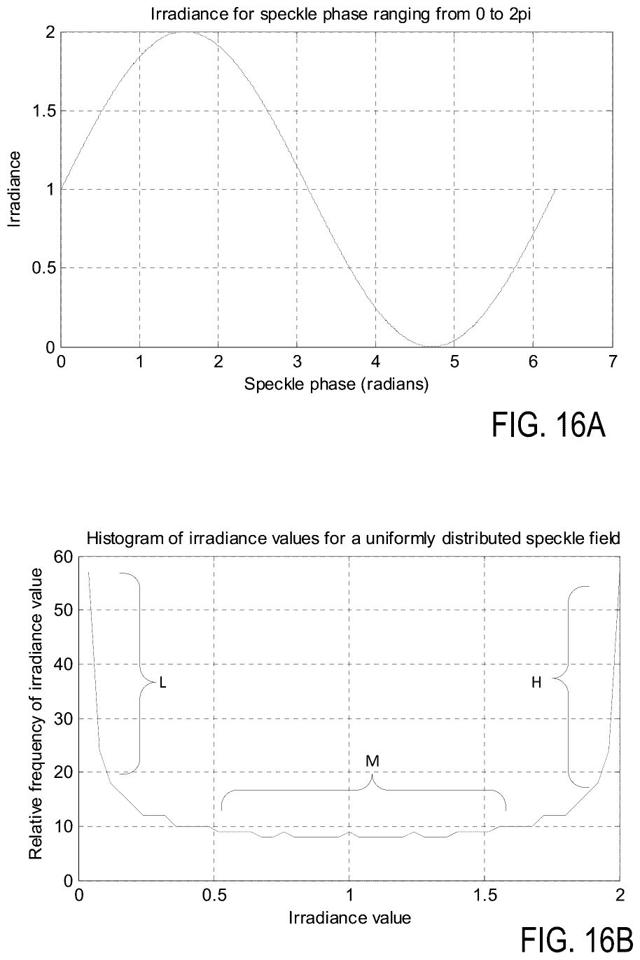

The systematic noise from speckle, however, cannot be reduced by this kind of averaging, since the systematic noise remains fixed as long as the optical imaging system remains fixed. In general, the phase of speckle is uniformly distributed between 0 and 2η, so if it were possible to change the phase of the speckle in discrete steps from 0 to 2η, then it would be possible to substantially precisely average out the speckle contrast everywhere in the image formed at the detector to the same value so that the speckle contrast did not cause errors. During the measurements, however, the opportunity of so-changing the phase of the speckle remains impractical if at all achievable. Indeed, FIG. 16A is a plot illustrating the irradiance distribution for speckle phase ranging from 0 to 2η, while FIG. 16B shows a relative histogram of the distribution of the irradiance in a speckle image. Clearly, there are incomparably more data measurement points representing very high and very low values of irradiance (see regions H, L) than there are those representing the mid-range of irradiance value (see region M). In certain application, changes in the SUT occur relatively slowly, so there is time available to introduce discrete-step changes and carry out the additional measurements. Several such approaches are disclosed below.

In further reference to the equations of FIG. 13, one can observe that all of the values in equations 1a) through 1d) possess certain spatial dependence (x,y) along the surface of the workpiece under test except for δx (the shear distance) and λ (the wavelength of light). Since the data representing Δ maps (or \tilde{Δ} maps discussed above) are being measured directly from the speckle interferograms, substantially any change introduced into the measurement system to change the speckle pattern will change the A (or \tilde{Δ}) maps, but will also change at least one of the other values in the equation set 1a) through 1d).

Example A: consider changing the source wavelength (that is, the wavelength of radiation used to irradiate the object 222). This could be done with a discrete set of lasers configured as one particular source of radiation, or with a tunable source such as a laser diode. The phase distribution of the speckle pattern comes from the height differences in the roughness of the test surface as a fraction of the source wavelength. Accordingly, if the source wavelength is changed, the phase distribution will also change because the same surface roughness will now produce a different phase delay, and therefore a different speckle pattern. In advantageous comparison with the situation when the measurements are carried out at the same, unchanged wavelength when at least four images have to be captured for the proper assessment of the change on the spatial profile of the object's surface (those before and after distortion change at more than 2 illumination angles), the measurements employing a variable wavelength source of radiation allows for dozens or more sets of data to be collected at various wavelengths. Averaging these results together understandably facilitates the reduction of the phase errors induced by the speckle. The optical system used for the measurements that employ a change of the radiation wavelength should preferably (but not necessarily) be designed to be substantially achromatic to handle the range of wavelengths of radiation produced by the source.

Example B: changing of the polarization of radiation used to irradiate the object under test (which, in one case, could be implemented prior to sending the light into a polarization maintaining (PM) fiber, see FIG. 4B). Such polarization change may not necessarily change the phase of the various scattered contributions to the acquired by the detector 244 signals, but it could change the relative amplitudes of such signals, as a result of which the speckle distribution at the detector will also be understandably changed.

Example C: Changing a position of the source with respect to the object under test (this corresponds to varying the value(s) of R, x, y and possibly z parameters of the equations of FIG. 13) results in a change of the angle at which the object is irradiated, which causes the rapid change of the phase distribution of radiation incident onto the object and, therefore, the speckle distribution at the plane of the detector. In practice, such change of the position should preferably be done in a highly repeatable fashion so that the sets of data, collected before and after the external input has been applied to the object, changes with the same position of irradiation. In one example, such change can be implemented with the use of a tiltable plane parallel optical plate disposed across the beam of radiation propagating from the source of radiation towards the detector (e.g., across the beam 220 of FIG. 2).

(Analogously to changing the source position would be changing the source angle. This could be done with a rotating wedge prism for high stability. In this alternative scenario, instead of tilting a plane parallel plate, one can use a wedge-shaped optically-transparent window between the source and the SUT. The beam passes through the window. The window is caused to rotate about the optical axis of the beam, but because of the tilt, such window changes the angle of the beam upon propagation.)

To various degrees, all of these proposed system perturbations will cause the change in the speckle distribution at the detector plane, which in turn will change the noise characteristics observed in the first derivative of the phase (Δ) maps (that is the quality of the map such as the map of FIG. 8). As a result, the proposed tangible changes introduced into the measurement system will advantageously change the systematic errors of the measurement facilitating the effective averaging of the systematic errors to reduce such systematic errors.

While simple averaging can be used to reduce measurements, other approaches can provide superior results. For example, weighted averaging of multiple Δ maps obtained from various wavelengths can be used. From each Δ map, relative brightness of speckle at each location is determined and used create a weighted average of the Δ maps. For example, if Δ map 1 at location A has 10% of the maximum power, but Δ map 2 at location A has 90% of the maximum power, 90% of the value from Δ map 2 and 10% of the value from Δ map 1 are combined. Relative speckle brightness can be based on one speckle or a group of speckles in a neighborhood about a location of interest, for example 2, 3, 5, 10, or 15 nearby speckles.

Some notes with respect to the object's surface may be in order. Preferably, the surface is chosen or configured such that a roughness figure (the rms value, for example) is larger than a wavelength of light that is incident upon it (for example, by a factor of 2 to 5), such that a variety of values of phase difference are present in light scattered back at the test system. Alternatively or in addition, the surface that does not transmit light (˜ opaque surface) may be preferred, because light-scatter from multiple depth points returned to the test system all at once will complicate the measurement: in such a case, the light coherence representing light scattered by different points on the SUT becomes too significant, a good measurement signal is unlikely to be generated. Measurements performed at multiple wavelengths may be preferred as such measurements can be carried out at the same time with separation of the results in in Fourier space. The reduction of systematic errors in this case is substantially proportional to the square root of the number of wavelengths used to perform the measurement.

### Example 9. Computer Environment

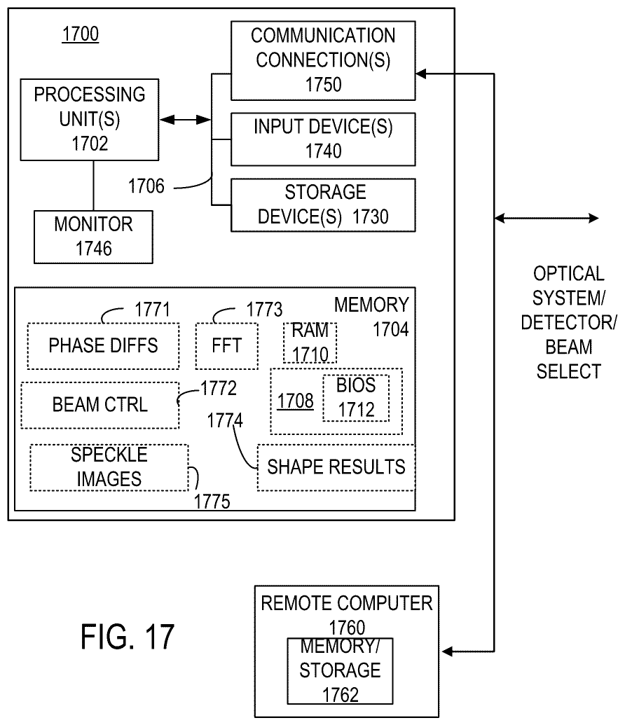

FIG. 17 and the following discussion are intended to provide a brief, general description of an exemplary computing environment in which the disclosed technology may be implemented for both phase and surface evaluation and instrument and system control. Although not required, the disclosed technology is described in the general context of computer-executable instructions, such as program modules, being executed by a personal computer (PC). Generally, program modules include routines, programs, objects, components, data structures, etc., that perform particular tasks or implement particular abstract data types. Moreover, the disclosed technology may be implemented with other computer system configurations, including hand-held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 17, an exemplary system for implementing the disclosed technology includes a general purpose computing device in the form of an exemplary conventional PC 1700, including one or more processing units 1702, a system memory 1704, and a system bus 1706 that couples various system components including the system memory 1704 to the one or more processing units 1702. The system bus 1706 may be any of several types of bus structures including a memory bus or memory controller, a peripheral bus, and a local bus using any of a variety of bus architectures. The exemplary system memory 1704 includes read only memory (ROM) 1708 and random access memory (RAM) 1710. A basic input/output system (BIOS) 1712, containing the basic routines that help with the transfer of information between elements within the PC 1700, is stored in ROM 1708. The memory 1704 also contains portions 1771-1774 that include computer-executable instructions and data for phase difference determinations, beam selection and control, and FFT and inverse FFT computations, and in-plane and out-of-plane shape data, respectively. In addition, a memory portion 1775 is operable to store images such as disclosed above.

The exemplary PC 1700 further includes one or more storage devices 1730 such as a hard disk drive for reading from and writing to a hard disk, a magnetic disk drive for reading from or writing to a removable magnetic disk, and an optical disk drive for reading from or writing to a removable optical disk (such as a CD-ROM or other optical media). Such storage devices can be connected to the system bus 1706 by a hard disk drive interface, a magnetic disk drive interface, and an optical drive interface, respectively. The drives and their associated computer-readable media provide nonvolatile storage of computer-readable instructions, data structures, program modules, and other data for the PC 1700. Other types of computer-readable media which can store data that is accessible by a PC, such as magnetic cassettes, flash memory cards, digital video disks, CDs, DVDs, RAMs, ROMs, and the like, may also be used in the exemplary operating environment.

A number of program modules may be stored in the storage devices 1730 including an operating system, one or more application programs, other program modules, and program data. A user may enter commands and information into the PC 1700 through one or more input devices 1740 such as a keyboard and a pointing device such as a mouse. Other input devices may include a digital camera, microphone, joystick, game pad, satellite dish, scanner, or the like. These and other input devices are often connected to the one or more processing units 1702 through a serial port interface that is coupled to the system bus 1706, but may be connected by other interfaces such as a parallel port, game port, or universal serial bus (USB). A monitor 1746 or other type of display device is also connected to the system bus 1706 via an interface, such as a video adapter. Other peripheral output devices, such as speakers and printers (not shown), may be included.

The PC 1700 may operate in a networked environment using logical connections to one or more remote computers, such as a remote computer 1760. In some examples, one or more network or communication connections 1750 are included. The remote computer 1760 may be another PC, a server, a router, a network PC, or a peer device or other common network node, and typically includes many or all of the elements described above relative to the PC 1700, although only a memory storage device 1762 has been illustrated in FIG. 17. The personal computer 1700 and/or the remote computer 1760 can be connected to a logical a local area network (LAN) and a wide area network (WAN). Such networking environments are commonplace in offices, enterprise-wide computer networks, intranets, and the Internet.

When used in a LAN networking environment, the PC 1700 is connected to the LAN through a network interface. When used in a WAN networking environment, the PC 1700 typically includes a modem or other means for establishing communications over the WAN, such as the Internet. In a networked environment, program modules depicted relative to the personal computer 1700, or portions thereof, may be stored in the remote memory storage device or other locations on the LAN or WAN. The network connections shown are exemplary, and other means of establishing a communications link between the computers may be used.

### General Considerations

As used in this application and in the claims, the singular forms “a,” “an,” and “the” include the plural forms unless the context clearly dictates otherwise. Additionally, the term “includes” means “comprises.” Further, the term “coupled” does not necessarily exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatuses are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation.

Terms such as beams, optical beams, and irradiation are used to describe propagating electromagnetic radiation, and in most examples at wavelengths between about 200 nm and 2000 nm but other wavelengths can be used. Such beams are not necessarily collimated, and in typical examples, a diverging beam such as emitted from an optical fiber can is used to irradiate an area of a surface. For convenience, beams are referred to as producing or being associated with speckle or speckle patterns. Such speckle patterns result from a summation of radiation portions received from target areas having random or quasi-random phase differences in imaging processes.

Terms such as wavefront duplicator or divider refer to optical systems that receive an optical beam and produce output beam portions having substantially the same wavefront shape. Examples include Wollaston prisms, Savart plates, diffraction gratings, and beamsplitter plates and cubes. As used herein, an image refers to a viewable image or data arranged so that a viewable image can be produced. Such data can be two dimensional data of various types, including images of objects, wavefront phases, wavefront amplitudes, interference patterns, and speckle patterns, including speckle interferograms. A “map” generally refers to values of phase or other quantity at a plurality of location, typically arranged as an image. In some examples, differences between so-called “initial” and “final” surface shapes are determined, but differences at arbitrary times can be obtained such as with or without a force or other perturbation applied. A time sequence of such maps can be produced and displayed as a video.

Having described and illustrated the principles of the disclosed subject matter with reference to the illustrated embodiments, it will be recognized that the illustrated embodiments can be modified in arrangement and detail without departing from such principles. For instance, elements of the illustrated embodiment shown in software may be implemented in hardware and vice-versa. Also, the technologies from any example can be combined with the technologies described in any one or more of the other examples. In view of the many possible embodiments to which these principles may be applied, it should be recognized that the illustrated embodiments are examples and should not be taken as a limitation on the scope of the disclosure. We therefore claim all subject matter that comes within the scope and spirit of these claims. Alternatives specifically addressed in these sections are merely exemplary and do not constitute all possible alternatives to the embodiments described herein.

We claim:

1. A method for determining a change in a shape a surface, comprising:
with the surface in a first state and with an initial first irradiation condition and an initial second irradiation condition:
(a) collecting a first distribution and a second distribution of radiation in an input plane of a measurement unit, the first distribution and the second distribution of radiation received from the surface in response to irradiation of the surface with a first beam at an initial first irradiation condition and second beam at an initial second irradiation condition;
(b) processing each of the first and second distributions of radiation associated with the surface in the first state to produce corresponding first and second wavefronts, introducing a shear between the first and second wavefronts, and directing overlapped first and second wavefronts to a radiation detector to produce a first image and a second image of the surface in the first state;
(c) based on the first image and the second image of the surface in the first state, obtaining corresponding first and second phase maps associated with the surface in the first state;
changing at least one geometrical parameter or at least one spectral parameter for each of the initial first and second irradiation conditions from initial values to produce modified first and second irradiation conditions; and
repeating steps (a)-(c) to obtain first and second phase maps.

2. The method of claim 1, further comprising:
with the surface in a second state and with the initial first irradiation condition and the initial second irradiation condition:
(a) collecting a first distribution and a second distribution of radiation in an input plane of a measurement unit, the first distribution and the second distribution of radiation received from the surface in response to irradiation of the surface with the first beam at the first irradiation condition and the second beam at the second irradiation condition;
(b) processing each of the first and second distributions of radiation associated with the surface in the second state to produce corresponding first and second wavefronts, introducing a shear between the first and second wavefronts, and directing overlapped first and second wavefronts to a radiation detector to produce a first image and a second image of the surface in the second state; and
(c) based on the first image and the second image in the second state, obtaining corresponding first and second phase maps associated with the surface in the second state; changing the at least one geometrical parameter or the at least one spectral parameter for each of the initial first and second irradiation conditions from initial values to produce the modified first and second irradiation conditions; and
repeating steps (a)-(c) to obtain first and second phase difference maps associated with the surface in the second state; and
obtaining a first phase difference map based on the first phase maps associated with the first state and the second state of the surface and a second phase difference map based on the second phase maps associated with the first state and the second state of the surface for the initial first and second radiation conditions and the modified first and second irradiation conditions.

3. The method of claim 2, further comprising:
averaging the first phase difference maps obtained with the initial and the modified irradiation conditions; and
averaging the second phase difference maps obtained with the initial and the modified irradiation conditions.

4. The method of claim 3, further comprising determining a change in the surface based on the first and second phase difference maps.

5. The method of claim 3, further comprising determining a map of surface changes based on the first and second phase difference maps.

6. The method of claim 1, wherein the first and second phase maps associated with the surface in the first state and in the second state are obtained by Fourier transforming the respective images, selecting a common diffraction order in each of the Fourier transformed images and obtaining an inverse Fourier transform of each of the selected common diffraction orders of each of the Fourier transformed images.

7. The method of claim 1, wherein the processing of each of the first and second distributions of radiation associated with the surface in the first state to produce corresponding first and second wavefronts, includes introducing a shear between the first and second wavefronts, and directing overlapped first and second wavefronts to a radiation detector to produce the first image and the second image of the surface in the first state.

8. The method of claim 1, wherein a dimension of the first distribution of radiation is at least one order of magnitude smaller than a spatial extent of the surface.

9. The method of claim 1, further comprising selecting subsets of the first and second images by Fourier transforming each of the first and second images and selecting portions at a spatial frequency that represents a difference in angles of propagation of the first and second wavefronts, wherein the first and second phase maps are based on the selected subsets.

10. The method of claim 3, further comprising selecting subsets of the first and second images associated with the surface in the first state and in the second state by Fourier transforming each of the first and second images associated with the surface in the first state and in the second state and selecting portions at a spatial frequency that represents a difference in angles of propagation of the first and second radiation wavefronts, wherein the first and second phase maps associated with the surface in the first state and the second state are based on the selected subsets.

11. The method of claim 1, further comprising changing at least one of respectively-corresponding geometrical parameters and respectively-corresponding spectral parameters for each of the first and second irradiation conditions from initial values to modified values.

12. The method of claim 10, wherein changing the at least one geometrical parameter or the at least one spectral parameter for each of the initial first and second irradiation conditions from initial values to the modified first and second irradiation conditions includes changing at least one of the geometrical and spectral parameters by the same absolute amount.

13. The method of claim 1, wherein changing the at least one geometrical parameter or the at least one spectral parameter for each of the initial first and second irradiation conditions from initial values to the modified first and second irradiation conditions includes changing at least one of the irradiation angles of propagation and wavelengths of the first and second beams of radiation.

14. The method of claim 1, wherein at least one of the first and second beams includes radiation having at least one wavelength in at least one of ultraviolet, visible, and infrared spectral regions.

15. The method of claim 1, further comprising producing the first beam with a first radiation source the second beam from a second radiation source so that the first beam and the second beam at least partially overlap at the surface.

16. The method of claim 15, wherein the first beam and the second beam are received at the surface simultaneously.

17. The method of claim 1, further comprising propagating the first beam towards the surface in a first direction and propagating the second beam towards the surface in a second direction, the first and second directions defining a plane of incidence to the surface, wherein the phase map is associated with shape changes in the plane of incidence.

18. The method of claim 2, further comprising:
with the surface in a first state and with the initial first irradiation condition and the initial second irradiation condition:
(a) collecting a third distribution and a fourth distribution of radiation in an input plane of a measurement unit, the third distribution and the fourth distribution of radiation received from the surface in response to irradiation of the surface with a third beam at a third irradiation condition and fourth beam at a fourth irradiation condition;
(b) processing each of the third and fourth distributions of radiation associated with the surface in the first state to produce corresponding first and second wavefronts, introducing a shear between the first and second wavefronts, and directing overlapped first and second wavefronts to a radiation detector to produce a third image and a fourth image of the surface in the first state;
(c) based on the third image and the fourth image of the surface in the first state, obtaining corresponding third and fourth phase maps associated with the surface in the first state;
with the surface in a second state and with the initial first irradiation condition and the initial second irradiation condition:
(d) collecting a third distribution and a fourth distribution of radiation in an input plane of a measurement unit, the third distribution and the fourth distribution of radiation received from the surface in response to irradiation of the surface with the third beam at the third irradiation condition and the fourth beam at the fourth irradiation condition;
(e) processing each of the third and fourth distributions of radiation associated with the surface in the second state to produce corresponding first and second wavefronts, introducing a shear between the first and second wavefronts, and directing overlapped first and second wavefronts to a radiation detector to produce a third image and a fourth image of the surface in the second state; and
(f) based on the third image and the fourth image in the second state, obtaining corresponding third and fourth phase maps associated with the surface in the second state;
obtaining a third phase difference map based on the third phase maps associated with the first state and the second state of the surface and a fourth phase difference map based on the fourth phase maps associated with the first state and the second state of the surface;
repeating steps (a)-(f) with the modified first irradiation condition and the modified second irradiation condition to obtaining a third phase difference map based on the third phase maps associated with the first state and the second state of the surface and a fourth phase difference map based on the fourth phase maps associated with the first state and the second state of the surface; and
determining in-plane changes in the surface based on the first and second phase difference maps and the third and fourth phase difference maps associated with the initial and modified irradiation conditions, wherein the determined changes are along different directions.

19. The method of claim 18, further comprising:
propagating the first beam and the second beam towards the surface in a first plane of incidence; and
propagating the third beam and the fourth beam towards the surface in a second plane of incidence that is different from the first plane of incidence, wherein the determined changes are in-plane change in the first and second planes of incidence.

20. The method of claim 1, wherein the first beam and the second beam are received at the surface at sequentially.

21. The method of claim 1, further comprising at least one of:
a) changing optical paths between first and second radiation sources, configured to respectively emit the first and second beams, and the surface to change angles of irradiation of the surface with the first and second beams; and
b) changing first and second radiation wavelengths in respective first and second beams of by the same amount;
c) changing optical paths by changing an average value of refractive index of a medium separating a radiation source and the surface as a result of modifying at least one of an optical parameter and a spatial positioning of at least one optical element;
d) changing optical paths by changing angles of incidence of the first and second beams onto the surface by repositioning of at least one optical element; and
e) changing optical paths by changing an average value of refractive index of a medium separating a radiation source and the surface as a result of modifying at least one of an optical parameter and a spatial positioning of at least one optical element; and
changing optical paths by changing a refractive index of an electro-optical (EO) medium of at least one optical element.

22. A shape measurement system, comprising:
an optical system coupled to produce speckle interferograms of a surface in a first state and a second state, the speckle interferograms associated with beams incident to the surface at least two angles of incidence; and
a processing system coupled to the optical system and configured to vary irradiation conditions of the beams and produce a surface map based on a plurality of speckle interferograms associated with the varied irradiation conditions.

23. The shape measurement system of claim 22, wherein the varied irradiation conditions are obtained by changing optical paths between the beams incident to the surface at the at least two angles of incidence.

24. The shape measurement system of claim 22, wherein the varied irradiation conditions are obtained by changing wavelengths of the beams incident to the surface at the at least two angles of incidence.

25. The shape measurement system of claim 22, wherein the varied irradiation conditions are obtained by changing optical paths by changing an average value of refractive index of a medium associated with at least one of the beams incident to the surface at the at least two angles of incidence.

26. The shape measurement system of claim 25, further comprising an electro-optical medium situated to change the average value of refractive index.
